(19) United States
(12) Patent Application Publication
(10) Pub. No.: US 2007/0198754 A1
(43) Pub. Date: Aug. 23, 2007

(54) Data transfer buffer control for performance

(75) Inventors: David W. Hill, Rochester, MN (US); John D. Irish, Rochester, MN (US); Jack C. Randolph, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/348,836

(22) Filed: Feb. 7, 2006

(51) Int. Cl. G06F 13/00

(52) U.S. Cl. 710/34

(57) ABSTRACT

Methods and apparatus for transferring data from a processing device to an I/O device via a data transfer buffer are provided. By signaling to an I/O device that data is available before an entire block size to be read out is written, the I/O device may begin read operations while the write is completed, thereby reducing latency. Latency may also be reduced by signaling the processing device that the buffer may be written to before the entire block size of data has been read by the I/O device, allowing the processor to begin writing the next block of data.

### BACKGROUND OF THE INVENTION

1. Field of the Invention

The present invention generally relates to data processing and, more particularly, to transferring data from a processor to an input/output (I/O) device via a data transfer buffer.

2. Description of the Related Art

In many computing applications, data is passed between a processing device and an input/output (I/O) device. As an example, in a gaming device, a central processor unit (CPU) may generate graphics primitives to be passed to a graphics processing unit (GPU) to use in rendering an image on a display. In many computing devices, a CPU may transfer data to a variety of devices via an I/O bridge device.

In some cases, an I/O device may not be ready to receive data from the CPU. Therefore, data from the CPU may be first held in local memory, such as a static random access memory (SRAM) array, until the I/O device communicates to the CPU that it is ready to receive the data. Once the I/O device has indicated it is ready, the data may be transferred from the SRAM array to the I/O device via a data transfer buffer.

Handshaking signals are typically used to notify the I/O device that data is available to be read from the buffer and to notify the CPU when the I/O device has read data from the buffer. In conventional systems, a signal indicating to the I/O device that data is available is not generated until some block size (known volume) of data, such as a full cache line, is available in the buffer. However, because there is some latency involved in reading after this “read ready” signal is generated, this approach compromises throughput. Further, conventional systems typically wait until a signal is generated indicating the entire block size of data is read from the buffer before signaling that subsequent writes to the buffer can occur. Again, because there is some latency involved in writing after this “write ready” signal is generated, this approach compromises throughput.

Accordingly, what is needed is an improved technique for transferring data from a processor to an I/O device via a data transfer buffer that reduces latency and improves throughput.

### SUMMARY OF THE INVENTION

The present invention generally provides improved techniques for transferring data from a processor to an I/O device via a data transfer buffer.

One embodiment provides a method for transferring data from a processor to an input/output (I/O) device via a data transfer buffer. The method generally includes detecting an amount of data from the processor available to be written to the data transfer buffer has been accumulated in an array, commencing write operations to write the data from the array to the data transfer buffer, and prior to completing operations to write all of the amount of data from the array to the transfer buffer, signaling an I/O interface that data is available in the data transfer buffer. The method further includes the I/O interface signaling that the data transfer buffer may be written with the next data transfer before the entire block size of data from a previous transfer has been read from the data transfer buffer.

Another embodiment provides a processing device generally including an embedded processor, an I/O interface allowing the embedded processor to communicate with external I/O devices, an array for accumulating data written by the embedded processor, a data transfer buffer for transferring data from the array to the I/O interface, and control logic. The control logic is generally configured to detect an amount of data from the processor available to be written to the data transfer buffer has been accumulated in an array, commence write operations to write the data from the array to the data transfer buffer, and prior to completing operations to write all of the amount of data from the array to the transfer buffer, signal the I/O interface that data is available in the data transfer buffer. The I/O interface is generally configured to signal that the data transfer buffer may be written with the next data transfer before the entire block size of data from the previous transfer has been read from the data transfer buffer.

Another embodiment provides a system, generally including at least one I/O device and a processing device. The processing device generally includes an embedded processor, an I/O interface allowing the embedded processor to communicate with the external I/O device, an array for accumulating data written by the embedded processor, a data transfer buffer for transferring data from the array to the I/O interface, and control logic. The control logic is generally configured to detect an amount of data from the processor available to be written to the data transfer buffer has been accumulated in an array, commence write operations to write the data from the array to the data transfer buffer, and prior to completing operations to write all of the amount of data from the array to the transfer buffer, signal the I/O interface that data is available in the data transfer buffer. The I/O interface is generally configured to signal that the data transfer buffer may be written with the next data transfer before the entire block size of data from the previous transfer has been read from the data transfer buffer.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system in accordance with one embodiment of the present invention.

FIG. 2 illustrates an exemplary data transfer buffer in accordance with one embodiment of the present invention.

FIG. 3 illustrates exemplary operations for transferring data from a processing device to an I/O device via a data transfer buffer in accordance with one embodiment of the present invention.

### DETAILED DESCRIPTION OF THE PREFERRED EMBODIMENTS

Embodiments of the present invention generally provide improved techniques for transferring data from a processing device to an I/O device via a data transfer buffer. By signaling to an I/O device that data is available before an entire block size to be read out is written, the I/O device may begin read operations while the write is completed, thereby reducing latency. Latency may also be reduced by signaling the processing device that the buffer may be written to before the entire block size of data has been read by the I/O device, allowing the processor to begin writing the next block of data.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

### An Exemplary System

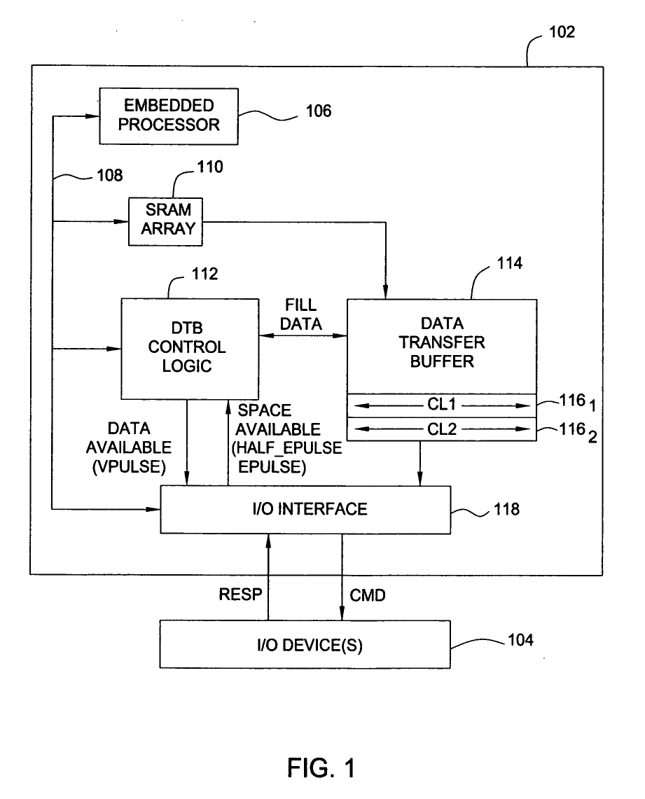

FIG. 1 is a block diagram illustrating a central processing unit (CPU) 102 coupled to one or more I/O devices 104, according to one embodiment of the invention. In one embodiment, the CPU 102 may reside within a computer system 100 such as a personal computer or gaming system and the I/O devices may include a graphics processing unit (GPU) and/or an I/O bridge device.

The CPU 102 may also include one or more embedded processors 106. The CPU 102 may be configured to write data to the I/O device 104, via an I/O interface 118. As illustrated, data transfer buffer (DTB) control logic 112 may control the transfer of data from the SRAM array 110 into a data transfer buffer 114. As will be described in greater detail below, aspects of the present invention may be embodied as operations performed by the data transfer buffer control logic 112 in order to increase data throughput.

During the write process, data may be transferred from a processor bus 108 to an SRAM array 110 until I/O device 104 indicates it is ready to read the data (e.g., by signaling the I/O interface 118). In some cases, data may not be written until an entire cache line has been accumulated in the SRAM array. Once the I/O device 104 has signaled it is ready to receive data, the I/O interface 118 may signal the DTB control logic 112 to start transferring data from the SRAM array 110 into the data transfer buffer 114.

The I/O interface 118 may read data from the data transfer buffer 114 and package the data into data packets, the exact size and format of the data packets depending on the particular I/O device 104 and a corresponding communications protocol. For some embodiments, the I/O interface may read 4 16 byte blocks from the data transfer buffer and package them into a single data packet and send them to an I/O device (e.g., a GPU or I/O bridge).

### An Exemplary Data Transfer Buffer

The data transfer buffer may be large enough to hold multiple cache line sized entries (e.g., two cache lines 116, and 1162). Data from the SRAM array 110 may be written to these cache lines 116 and data may be read from these cache lines by the I/O interface 118. Utilizing cache-line size entries (e.g., entries the same size as cache line entries in a cache utilized by the embedded processor 106) may facilitate data transfer to and from the embedded processor 106.

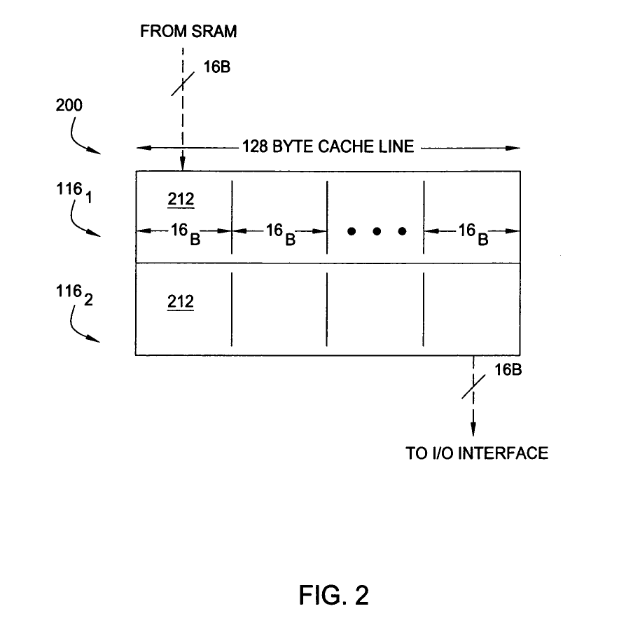

As illustrated in FIG. 2, each cache line 116 may consist of eight 16 byte blocks 212, which may correspond to 16 byte packets of data written onto the processor bus 108 into the SRAM array 110 by the embedded processor 106. As illustrated, data from the SRAM 110 may be written into the cache lines in 16 byte blocks. Similarly, data may be read out of the data transfer buffer 114 in 16 byte blocks.

For some embodiments, utilizing multiple cache lines may allow the DTB control logic 112 to alternate between cache lines. An advantage to this approach is that one cache line can be filled while the other is being read out. In this manner, even if read operations fall behind, an alternate cache line may be available to hold the data. As will be described below, for some embodiments, the I/O interface may be configured to generate signals indicating when the I/O interface has read a particular amount (e.g., one half) of the data from a given cache line. Such a signal notifies the DTB logic that there is sufficient room to begin writing data from the SRAM array to a targeted cache line.

Write data from the processor bus 108 is stored in an SRAM array 110 until the data is ready for transfer to the I/O interface. Signaling a read of the data from the SRAM array 110 and writing it into the data transfer buffer 114 will have some amount of associated latency, for example, five cycles for some embodiments. Once read, the data may be written into the data transfer buffer 114. Therefore, for some embodiments, the DTB control logic 112 may be configured to ensure there is space for 5 cycles of data, equal to five 16 byte packets. The DTB control logic 112 may look ahead 5 slots in the data transfer buffer 114 to determine if more data should be fetched from the SRAM array 110.

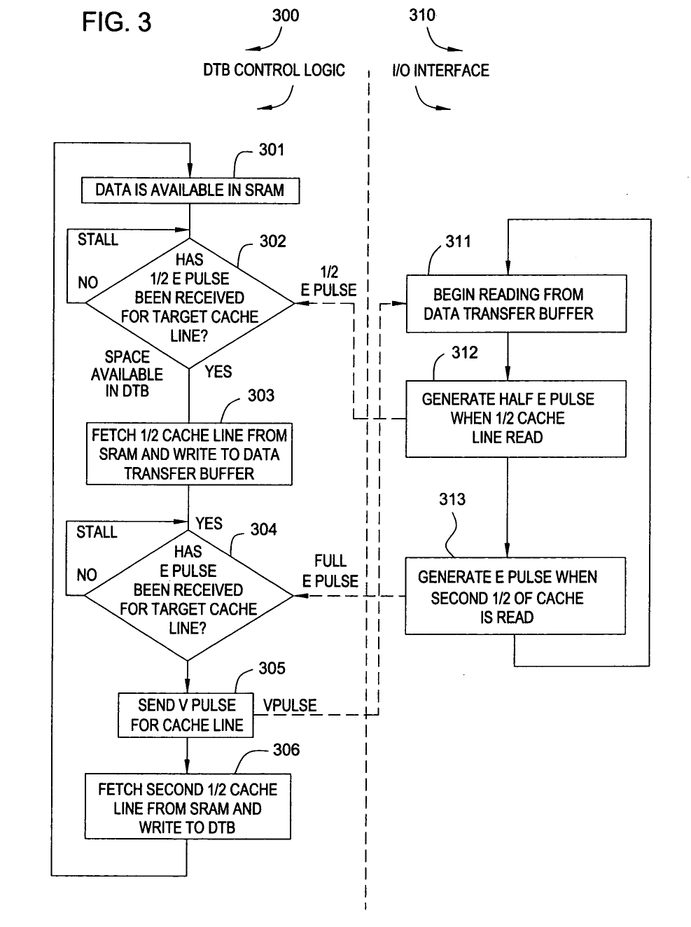

FIG. 3 illustrates exemplary operations 300 and 310 that may be performed, for example, by the DTB control logic 112 and I/O interface logic 118, respectively, to transfer data from the embedded processor 106 to an I/O device in a manner with reduced latency. If multiple cache lines are utilized in the data transfer buffer, the operations 300 may be performed by the DTB control logic 112 to transfer data from the SRAM array 110 into one cache line, while the operations 310 may be performed by the I/O interface to simultaneously read data from another cache line.

For some embodiments, the DTB control implementation of signaling when data is available in conjunction with a first write (via a vpulse signal) allows I/O interface reads to occur one cycle after writes. As a result, the I/O interface can read a 16 byte block of a cache line while the next 16 byte of cache line is being written into the data transfer buffer 114. This approach provides for very low latency through the data transfer buffer 114.

The operations 300 that may performed by the DTB control logic 112 will be described first. The operations begin, at step 301, when data becomes available in the SRAM array 110, for example, after the embedded processor 106 has issued a write command via the processor bus 108.

In response to the data becoming available, the DTB control logic 112 will determine, at step 302, if a “half empty” signal (referred to herein as a half e-pulse) has been received from the I/O interface indicating the I/O interface has read at least half of the data from the cache line 116 targeted to receive the SRAM array data. If a half e-pulse has not been received, there is no guarantee of space in the data transfer buffer 114, and the DTB control logic waits. Receipt of the half e-pulse indicates there is room (at least half of a cache line 116) in the data transfer buffer 114 and so the DTB control logic 118 fetches a first half cache line from the SRAM array 110, at step 303 and begins to write it to the data transfer buffer 114. It should be noted that, rather than half, any other suitable fraction may also be used as a basis of generating a “partially” empty signal.

At step 304, the DTB control logic determines if a “full empty” signal (referred to herein as an e-pulse) has been received from the I/O interface indicating the I/O interface has read the entire cache line targeted to receive the SRAM data. If so, there is an enough room in the DTB 114 for the entire cache line and the DTB logic can guarantee that writes into the DTB 114 can stay ahead of reads out of the DTB. Therefore, the DTB control logic 112 may send a signal (referred to herein as a vpulse) to the I/O interface 118 indicating data is available in the DTB to read, at step 305. In this manner, a read to a first half of a cache line by the I/O interface 118 may be allowed, while the DTB control logic 112 is still writing to the second half of the same cache line.

In one embodiment, a write may stall, thereby allowing reads to possibly overtake the writes, causing underflow and a corresponding data loss. Therefore, if the e-pulse is not received for the targeted cache line meaning there is no guarantee writes into the DTB can stay ahead of reads, the DTB control logic waits (stalls) to generate the vpulse signal. Once an epulse is received from the I/O interface and after the vpulse is sent, at step 305, the DTB logic fetches the second half of the cache line from the SRAM array 110 and writes it to the DTB logic 112, at step 306.

The I/O interface implementation of utilizing a half epulse allows the DTB control logic 112 to write to the (1^{st} half of the) same cache line that is being read (2^{nd} half) from by the I/O interface 118 while DTB control is writting the 1st half with different cache line data). While reads are normally faster than writes, stalls can still occur due to contention for resource. Utilizing this approach, the DTB control logic 112 may keep the data transfer buffer 114 close to as full as possible at all times such that there is always a maximum amount of available data to transfer, thus improving throughput.

Referring now to the operations 310 that may be performed by the I/O interface, as soon as the I/O interface 118 receives a vpulse signal from the DTB control logic 112, it may begin reading from the data transfer buffer, at step 311. Once a predetermined amount of data has been read (half in this example), the half epulse is sent to the DTB control logic 112, at step 312. Once the entire cache line has been read, the I/O interface logic 118 generates a full e-pulse, at step 313.

In this manner, if the vpulse is not delayed, the I/O interface 118 can actually read the data transfer buffer 114 before a full cache line is written, thereby reducing latency. Further, the DTB control logic 118 allows back to back cache line fetches and writes to the data transfer buffer, provided that half_epulses/epulses stay ahead of the fetch look-ahead logic, thus ensuring maximum throughput if the I/O interface does not stall.

As previously described, for some embodiments, the DTB control logic 112 may be configured to ensure there is space for 5 cycles of data, equal to 5 16 byte packets in the data transfer buffer. Therefore, the DTB control logic 112 may look ahead 5 slots in the data transfer buffer to determine if more data should be fetched from the SRAM array 110. Low latency may be enhanced by sending the vpulse with first write to transfer buffer and using the half_epulse to speculatively determine whether to start the next cache line transfer. As long as an epulse is received in the next 4 cycles, the writes do not stall.

### CONCLUSION

By signaling reads to start before entire data structures (e.g., cache lines) have been written to a data transfer buffer, latency typically associated with such reads may be reduced. Further, by signaling writes to start before an entire data structure has been read, latency typically associated with such write operations may be reduced, thereby improving overall data throughput.

What is claimed is:

1. A method for transferring data from a processor to an input/output (I/O) device via a data transfer buffer, comprising:
detecting an amount of data from the processor available to be written to the data transfer buffer has been accumulated in an array;
commencing write operations to write the data from the array to the data transfer buffer;
signaling an I/O interface, prior to completing operations to write all of the amount of data from the array to the transfer buffer, that data is available in the data transfer buffer;
determining if there is space available in the data transfer buffer, by determining if a signal indicating the I/O interface has read some predetermined amount of data has been received, prior to commencing the write operations.

2. The method of claim 1, wherein detecting an amount of data from the processor available to be written to the data transfer buffer has been accumulated in an array comprises detecting that a cache-line amount of data has been accumulated in the array.

3. The method of claim 1, wherein the write operations comprise writing data into the data transfer buffer a block of data at a time.

4. The method of claim 3, wherein:
the data transfer buffer comprises one or more cache lines; and
the write operations comprise writing data into the data transfer buffer a block of data at a time until an entire cache line has been filled.

5. The method of claim 1, further comprising:
determining if a signal indicating the I/O interface has read a predetermined amount of data from the data transfer buffer has been received; and
if not, stalling before signaling the I/O interface that data is available in the data transfer buffer.

6. The method of claim 4, further comprising:
commencing additional write operations to a different cache line without stalling, provided one or more signals indicating the I/O interface has read some predetermined amount of data from the data transfer buffer have been received.

7. A processing device, comprising:
an embedded processor;
an I/O interface allowing the embedded processor to communicate with external I/O devices;
an array for accumulating data written by the embedded processor;
a data transfer buffer for transferring data from the array to the I/O interface;
control logic configured to detect an amount of data from the processor available to be written to the data transfer buffer has been accumulated in an array, commence write operations to write the data from the array to the data transfer buffer, and prior to completing operations to write all of the amount of data from the array to the transfer buffer, signal the I/O interface that data is available in the data transfer buffer; and
control logic further configured to determine if there is space available in the data transfer buffer, by determining if a signal has been received indicating the I/O interface has read some predetermined amount of data from a cache line targeted to receive the written data, prior to commencing the write operations.

8. The device of claim 7, wherein the I/O interface is configured to generate a first signal indicating the I/O interface has read some predetermined amount of a cache line from the data transfer buffer.

9. The device of claim 8, wherein the I/O interface is configured to generate a second signal indicating the I/O interface has read the entire amount of a cache line from the data transfer buffer.

10. The device of claim 7, wherein:
the data transfer buffer comprises one or more cache lines; and
the write operations comprise writing data into the data transfer buffer a block of data at a time until an entire cache line has been filled.

11. The device of claim 7, wherein the control logic is further configured to determine if a signal indicating the I/O interface has read a predetermined amount of data from the data transfer buffer has been received and if not, stalling before signaling the I/O interface that data is available in the data transfer buffer.

12. The device of claim 7, wherein the data transfer buffer comprises multiple cache lines and the control logic is configured to alternate between different cache lines when writing data from the array.

13. The device of claim 7, wherein the control logic is further configured to commence additional write operations to a different cache line without stalling, provided one or more signals indicating the I/O interface has read some predetermined amount of data from the data transfer buffer have been received.

14. A system, comprising:
at least one I/O device; and
a processing device comprising an embedded processor, an I/O interface, configured to generate a first signal indicating the I/O interface has read some predetermined amount of a cache line from the data transfer buffer, allowing the embedded processor to communicate with the external I/O device, an array for accumulating data written by the embedded processor, a data transfer buffer for transferring data from the array to the I/O interface, and control logic configured to detect an amount of data from the processor available to be written to the data transfer buffer has been accumulated in an array, commence write operations to write the data from the array to the data transfer buffer, and prior to completing operations to write all of the amount of data from the array to the transfer buffer, signal the I/O interface that data is available in the data transfer buffer.

15. The system of claim 14, wherein the I/O interface is configured to generate a second signal indicating the I/O interface has read the entire amount of a cache line from the data transfer buffer.

16. The system of claim 14, wherein at least one I/O device comprises a graphics processing unit (GPU).

17. The system of claim 14, wherein at least one I/O device comprises an I/O bridge device.

18. The system of claim 14, wherein the control logic is further configured to commence additional write operations to a different cache line without stalling, provided one or more signals indicating the I/O interface has read some predetermined amount of data from the data transfer buffer have been received.
